(19) United States
(12) Patent Application Publication
(10) Pub. No.: US 2009/0151493 A1
(43) Pub. Date: Jun. 18, 2009

(54) ROLLING-ELEMENT SCREW DEVICE AND METHOD OF ASSEMBLING THE SAME

(75) Inventor: Soshi Miyahara, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: THK CO., LTD., Tokyo (JP)

(21) Appl. No.: 12/064,752

(22) PCT Filed: Aug. 22, 2006
(86) PCT No.: PCT/JP2006/316357

§ 371 Date: Feb. 25, 2008

(30) Foreign Application Priority Data
Aug. 25, 2005 (JP) 2005-243773

(51) Int. Cl. F16H 25/22; B23P 11/00; F16H 25/24

(52) U.S. Cl. 74/424.87; 29/428

(57) ABSTRACT

The present invention provides a rolling-element screw device capable of offering advantages of both an end cap type ball screw and a return pipe type ball screw and belonging to an intermediate new category between these ball screws.

The rolling-element screw device is provided with a circulation member 13 for scooping up each rolling element 19, which has rolled up to one end of a loaded rolling-element rolling groove 14b of a nut main body 14, and returning the rolling element 19 to the other end of the loaded rolling-element rolling groove 14b. The circulation member 13 consists of two members, that is, a first pipe 11 and a second pipe 12. The first pipe 11 is attached to one axial end surface 14a of the nut main body 14 while the second pipe 12 is attached to an axially opposite end surface of the nut main body 14.

### TECHNICAL FIELD

The present invention relates to a rolling-element screw device having a screw shaft, a nut and rolling elements rollably disposed therebetween and also to a method of assembling the same.

### BACKGROUND ART

As a ball screw having balls rollably disposed between a screw shaft and a nut allows reduction of friction coefficient in rotating the screw shaft relative to the nut as compared with a sliding contact type screw, it has become commercially practical in various fields such as positioning mechanism of machine tools, vehicle steering, guide devices, motion screws and the like. In such a ball screw, a spiral ball rolling groove of the screw shaft and a loaded ball rolling groove of the nut are aligned to form a path, which is filled with a plurality of balls, and the nut is provided with a circulation member for circulating the balls. Once each ball rolls up to an end of the loaded ball rolling groove of the nut, the ball is scooped up into the circulation member. After passing through the circulation member, the ball returns several turns back to the other end of the loaded ball rolling groove.

The ball circulation system of the ball screw includes a return pipe type ball circulation system and an end cap type ball circulation system. The return pipe type ball screw adopts a return pipe 1 for ball circulation as illustrated in FIG. 12. Each ball 4 is scooped up from the outer surface of the screw shaft 3 by the return pipe 1 and passes through the return pipe to return to the original position. The return pipe 1 is first mounted on the side surface of the nut main body. Then, a pair of leg parts of the return pipe 1 is inserted into holes 2a formed on the side surface of the nut main body 2.

As illustrated in FIGS. 13(A) and 13(B), in order to circulate balls 4 smoothly, each ball 4 rolling on the outer surface of the screw shaft is sometimes scooped up in the tangential direction of the spiral ball circulation raceway and in the lead angle direction. When seen from the side surface in FIG. 13(B), paired leg parts 1a of the return pipe 1 are V shaped. In order to prevent interference between the leg parts 1a of the return pipe 1 and the holes 2a of the nut main body 2, it is required to make the holes 2a longer in the side surface of the nut main body 2, which is apt to cause play around each of the leg parts 1a. This is more pronounced as the lead of the screw shaft 3 is larger. An example of a return pipe having leg parts inclined in accordance with the lead of the screw shaft is also disclosed, for example, in the patent document 1.

Meanwhile, in the end cap type ball screw, as illustrated in FIG. 14, each ball 6 rolling on the outer surface of the screw shaft 5 is scooped up by an end cap 8 attached to one end surface of the nut main body 7, made to pass through the inside of the nut main body 7 and returned onto the outer surface of the screw shaft via an end cap 8 attached to the opposite end surface of the nut main body 7 (for example, see patent document 2). In the end cap type ball screw, the end cap 8 attached to each end surface of the nut main body 7 has a direction change path 9 and a scooping portion formed for scooping balls. With this structure, there is no play caused, even in a ball screw having a large lead, which differs from the case of return pipe type.

Patent document 1: Japanese patent laid-open publication No. 3-121341
Patent document 2: WO03/21133A1, pamphlet

### DISCLOSURE OF THE INVENTION

### Problems to be Solved by the Invention

However, such an end cap type ball screw has a circulation member consisting of three members, that is, a nut main body and end caps provided on the respective ends of the nut main body, which shows drawbacks of a high parts count and high possibility of elevation change for ball rolling at two joints of the three components, as compared with a return pipe ball screw. Besides, there is a need to equip the nut main body with a path for ball rolling, which results in that the outer shape of the nut main body is likely to be larger.

Therefore, the present invention has an object to provide a rolling-element screw device capable of offering advantages of both end cap type ball screw and a return pipe type ball screw and belonging to an intermediate new category between these ball screws.

### Means for Solving the Problems

The present invention will now be described below.

In order to solve the above-mentioned problems, the invention of claim 1 is a rolling-element screw device comprising: a screw shaft having an outer surface with a rolling-element rolling groove spirally formed thereon; a nut main body having an inner surface with a loaded rolling-element rolling groove spirally formed thereon facing the rolling-element rolling groove of the screw shaft; a plurality of rolling elements arranged between the rolling-element rolling groove of the screw shaft and the loaded rolling-element rolling groove of the nut main body; and a circulation member for, after each of the rolling elements rolls up to one end of the loaded rolling-element rolling groove of the nut main body, scooping up the rolling element and returning the rolling element to an opposite end of the loaded rolling-element rolling groove, the circulation member having a first pipe and a second pipe each having a scooping portion formed at one end thereof for scooping up each of the rolling elements and a direction change path extending in a curve, the first pipe being attached to one axial end surface of the nut main body, and the second pipe being attached to an axially opposite end surface of the nut main body.

The invention of claim 2 is characterized in that, in the rolling-element screw device according to claim 1, the first pipe is fit to a notch formed in the one axial end surface of the nut main body, and the second pipe is fit to a notch formed in the axially opposite end surface of the nut main body.

The invention of claim 3 is characterized in that, in the rolling-element screw device according to claim 2, in a side surface of the nut main body, a side-surface groove is formed linked to the notch formed in the one end surface and the notch formed in the opposite end surface of the nut main body, and the first pipe and the second pipe are fit into the side-surface groove and exposed on the nut main body.

The invention of claim 4 is characterized by, in the rolling-element screw device according to any one of claims 1 to 3, further comprising: a pair of first support members having main body parts attached to the respective end surfaces of the nut main body and protruding portions conforming to shapes of the first pipe and the second pipe, and being configured to hold the first pipe and second pipe down onto the respective end surfaces of the nut main body; and a second support member attached to a side surface of the nut main body and being configured to hold the first pipe and the second pipe down onto the side surface of the nut main body at a position of mating surfaces of the first pipe and the second pipe.

The invention of claim 5 is characterized in that, in the rolling-element screw device according to any one of claims 1 to 4, mating surfaces of the first pipe and the second pipe include first mating surfaces positioned in planes including center lines of the first pipe and the second pipe, second mating surfaces and third mating surfaces provided away from each other along the respective center lines and at respective opposite sides of the first mating surfaces.

The invention of claim 6 is a method of assembling a rolling-element screw device having a plurality of rolling elements arranged between a rolling-element rolling groove spirally formed on an outer surface of a screw shaft and a loaded rolling-element rolling groove spirally formed on an inner surface of a nut main body, and a circulation member for, after each of the rolling elements rolls up to one end of the loaded rolling-element rolling groove of the nut main body, scooping up the rolling element and returning the rolling element to an opposite end of the loaded rolling-element rolling groove, the circulation member having a first pipe and a second pipe each having a scooping portion formed at one end thereof for scooping up each of the rolling elements and a direction change path extending in a curve, comprising: moving the first pipe toward one axial end surface of the nut main body to attach the first pipe thereto; moving the second pipe toward an axially opposite end surface of the nut main body to attach the second pipe thereto; and holding the first pipe and the second pipe down onto the nut main body with a support member.

### EFFECTS OF THE INVENTION

According to the invention of claim 1, as the first and second pipes are mounted onto the respective end surfaces of the nut main body, it is possible to prevent play from being introduced around the first and second pipes, in contrast to the return pipe type ball screw of which the return pipe is mounted on the side surface of the nut main body. Moreover, as the circulation member consists of the two members, that is, the first and second pipes, it is possible to realize the ball screw with a lower parts count than that of a conventional end cap type ball screw and to minimize the number of joints of the different parts for movement of rolling elements.

According to the invention of claim 2, as the first and second pipes are fit into the notches formed in the respective end surfaces of the nut main body, it is more possible to prevent play from being introduced around the first and second pipes.

According to the invention of claim 3, it is possible to downsize the outer shape of the nut main body.

According to the invention of claim 4, it is possible to position the first and second pipes at the mating surfaces thereof.

According to the invention of claim 5, it is possible to mount the first and second pipes onto the nut main body with use of the first and second support members. Besides, as each of the first support members is provided with a protruding portion which conforms to the shapes of the first and second pipes, it is possible to prevent play from being introduced around the first and second pipes.

According to the invention of claim 6, the first and second pipes are first fit to the respective end surfaces of the nut main body and then the first and second pipes are able to be mounted onto the nut main body only by holding tight the first and second pipes with the support members. With this method, assembly is facilitated.

### BRIEF DESCRIPTION OF THE DRAWINGS

FIG. 1 is a perspective view of a ball screw according to one embodiment of the present invention;

FIG. 2 is an exploded perspective view of the above-described ball screw;

FIG. 3 is a perspective view of a first pipe and a second pipe;

FIG. 4 is a top view of the first and second pipes;

FIG. 5 is a front view of the ball screw;

FIG. 6 is a lateral view of the ball screw;

FIG. 7 is a perspective view illustrating a leg part of the first pipe seen from the inner-diameter side of the nut main body;

FIG. 8 is a view illustrating the leg part tilting seen in the axial direction of the screw shaft;

FIG. 9 is a view illustrating the leg part tilting seen from the lateral side of the screw shaft;

FIG. 10 is a detail view of a first support member;

FIG. 11 is a detail view of a second support member;

FIG. 12 is a perspective view illustrating a conventional return pipe type ball screw;

FIGS. 13(A) and 13(B) are views each illustrating ball circulation of a conventional return pipe type ball screw (FIG. 13(A) illustrating the ball circulation seen in the axial direction of the screw shaft, and FIG. 13(B) illustrating the ball circulation seen from the lateral side of the screw shaft; and

FIG. 14 is a cross-sectional view of a conventional end cap type ball screw.

### DESCRIPTION OF REFERENCE NUMERALS

11 . . . first pipe (circulation member)
12 . . . second pipe (circulation member)
11a . . . leg part of first pipe
12a . . . leg part of second pipe
11c, 12c . . . first mating surfaces
11d, 12d . . . second mating surfaces
11e, 12e . . . third mating surfaces
13 . . . circulation member
14 . . . nut main body
14a . . . end surface
14b . . . loaded ball rolling groove (loaded rolling-element rolling groove)
15 . . . notch
16 . . . side-surface groove
18a . . . ball rolling groove
18 . . . screw device
19 . . . ball (rolling element)
20 . . . scooping portion
21 . . . first support member
21a . . . main body part
21b . . . protruding portion
22 . . . second support member

### BEST MODE FOR CARRYING OUT THE INVENTION

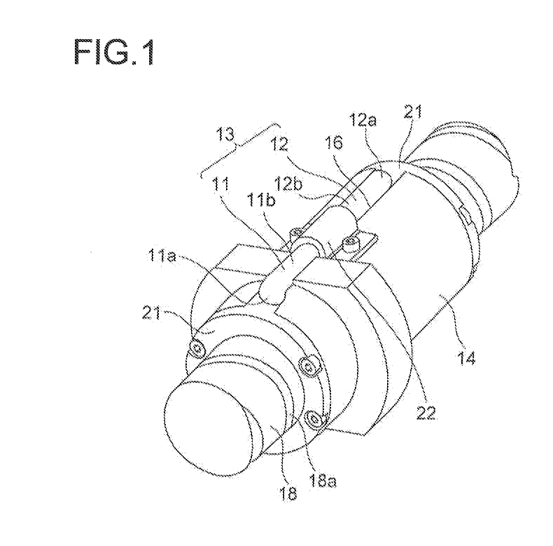

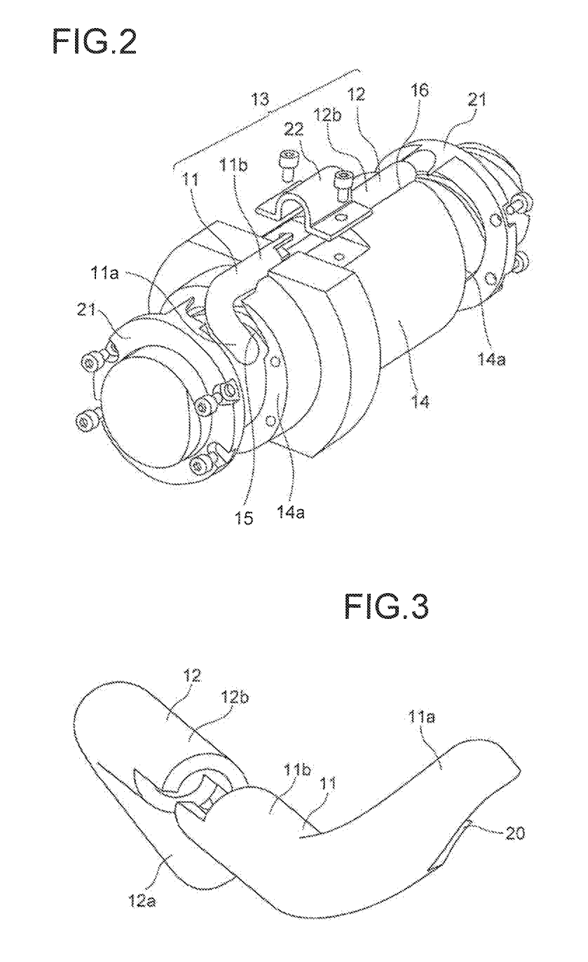

With reference to the attached drawings, an embodiment of the present invention will now be described in detail below. FIG. 1 is a perspective view of a ball screw as a rolling-element screw device according to one embodiment of the present invention, and FIG. 2 is an exploded perspective view of the ball screw. The ball screw of this embodiment belongs to an intermediate new category between a return pipe type ball screw and an end cap type ball screw. Hence, description is first made about outlines of the ball screw of this embodiment in comparison with the return pipe type ball screw and the end cap type ball screw.

The ball screw of this embodiment is apparently close to a return pipe type ball screw because a pipe is seen exposed. In the return pipe type ball screw, a leg part of the return pipe is inserted into a long hole formed in the side surface of a nut main body, which causes play around the leg part. On the other hand, in the ball screw of this embodiment, a circulation member 13 is composed of two longitudinally divided pipes, that is, a first pipe 11 and a second pipe 12, and the leg parts 11a and 12a of the first and second pipes 11 and 12, respectively, are fit to notches 15 formed in the both end surfaces 14a of the nut main body 14. Each of the notches 15 is formed in the end surface 14a of the nut main body 14 by an end mill in such a manner that the leg parts 11a and 12a of the first and second pipes 11 and 12 tilting in accordance with the lead angle are tightly fit (without clearance) to the notches. The first and second pipes 11 and 12 fit to the notches 15 from the respective end surfaces 14a of the nut main body 14, not from the side surface side of the nut main body 14. In the side surface of the nut main body 14, a side-surface groove 16 extends in the axial direction, which is formed by an end mill. This side-surface groove 16 is linked to the notches in the end surfaces 14a of the nut main body 14. In this side-surface groove 16, straight parts 11b and 12b of the first and second pipes 11 and 12 fit thereon.

Meanwhile, the end cap type ball screw is a ball screw having a pair of end caps attached to respective ends of the nut main body. A circulation member thereof consists of three members, that is, a direction change part formed in one end cap, a straight part formed in the nut main body and a direction change part formed in the other end cap. On the other hand, in the ball screw of this embodiment, as one feature, the circulation member consists of two members, that is, the first and second pipes 11 and 12, and the first and second pipes 11 and 12 are exposed at the nut main body 14.

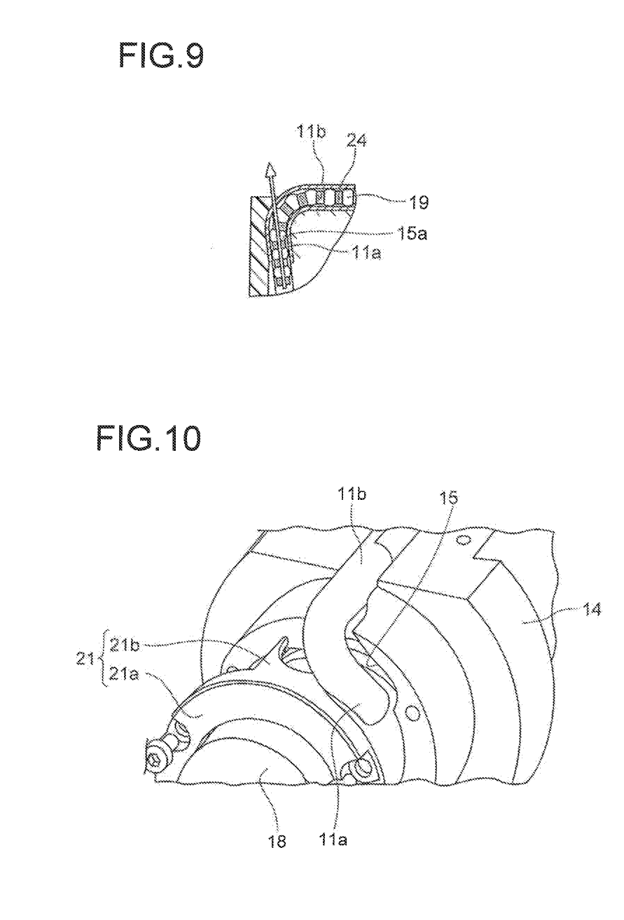

Next description is made in detail about the structure of each part of the ball screw. As illustrated in FIGS. 1 and 2, the ball screw has a screw shaft 18 having an outer surface with a ball rolling groove 18a spirally formed thereon, and a nut main body 14 having an inner surface with a loaded ball rolling groove 14b spirally formed thereon facing the ball rolling groove 18a. Between the ball rolling groove 18a of the screw shaft 18 and the loaded ball rolling groove 14b of the nut main body 14, there is formed a loaded ball rolling path A, in which a plurality of balls 19 is arranged rollably. Between balls 19, a spacer 24 is provided to prevent contact between the balls 19 (see FIGS. 8 and 9).

The ball rolling groove 18a spirally formed on the outer surface of the screw shaft has a predetermined lead. The cross section of the ball rolling groove 18a of the screw shaft 18 is shaped, for example, like a Gothic arch consisting of combined two circular arcs, or the like. The number of threads of the ball rolling groove 18a may be one, two, three or any number optionally. Needless to say, if the ball rolling groove has plural threads, plural circulation members and ball rolling grooves are also required in accordance with the number of the threads.

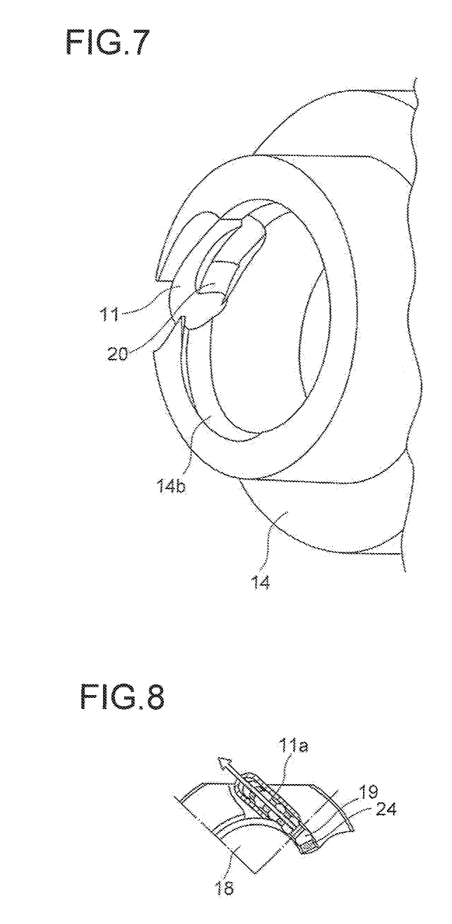

On the inner surface of the nut main body 14, the loaded ball rolling groove 14b is formed spirally facing the ball rolling groove 18a of the screw shaft 18 (see FIG. 7). Like the cross section of the ball rolling groove 18a of the screw shaft 18, the cross section of the loaded ball rolling groove 14b is also shaped like a Gothic arch consisting of combined two circular arcs, or the like.

In order to circulate each ball 19, which has rolled up to an end of the loaded ball rolling groove 14b of the nut main body 14, there is a circulation member 13 mounted on the nut main body 14. The circulation member 13 has a return path connecting one end of the loaded ball rolling groove 14b to the other. After each ball 19 has rolled up to one end of the loaded ball rolling groove 14b, the circulation member 13 scoops up the ball 19 (see FIG. 8), makes the ball 19 pass through the return path thereof, and returns the ball 19 several-turn back to the other end of the loaded ball rolling groove 14b. This circulation member 13 is composed of longitudinally divided two pipes, that is, a first pipe 11 and a second pipe 12.

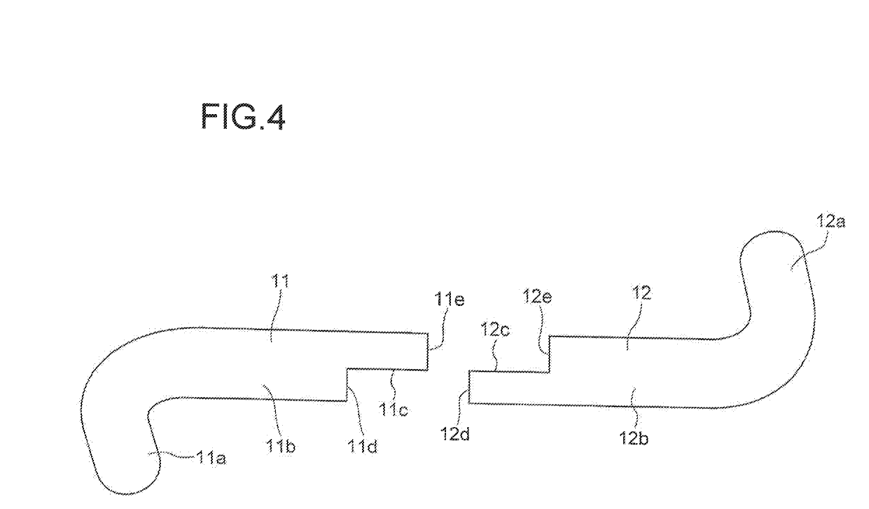

FIGS. 3 and 4 illustrate the first pipe 11 and the second pipe 12. The first pipe 11 and the second pipe 12 are bent into L shape and have straight parts 11b and 12b and leg parts 11a and 12a, respectively. In the straight parts 11b and 12b, a straight path is formed. The first pipe 11 and the second pipe 12 have, at their respective ends, mating surfaces for connecting the first pipe 11 and the second pipe 12 together. The mating surfaces include first mating surfaces 11c and 12c in planes including the center lines of the first pipe 11 and the second pipe 12, respectively, second mating surfaces 11d and 12d and third mating surfaces 11e and 12e provided away from each other in the respective center line directions and at respective opposite sides of the first mating surfaces 11c and 12c. The mating surfaces are formed having steps. Meanwhile, in the leg parts 11a and 12a, there are formed direction change paths each of which extends continuously from the straight path into a curve. At ends of the leg parts 11a and 12a, respective scooping portions 20 are provided for scooping the balls 19. These first and second pipes 11 and 12 can be manufactured by bending metal pipes or injection molding of resin. Where the first and second pipes 11 and 12 are injection molded, they are divided at a division plane including the respective center lines.

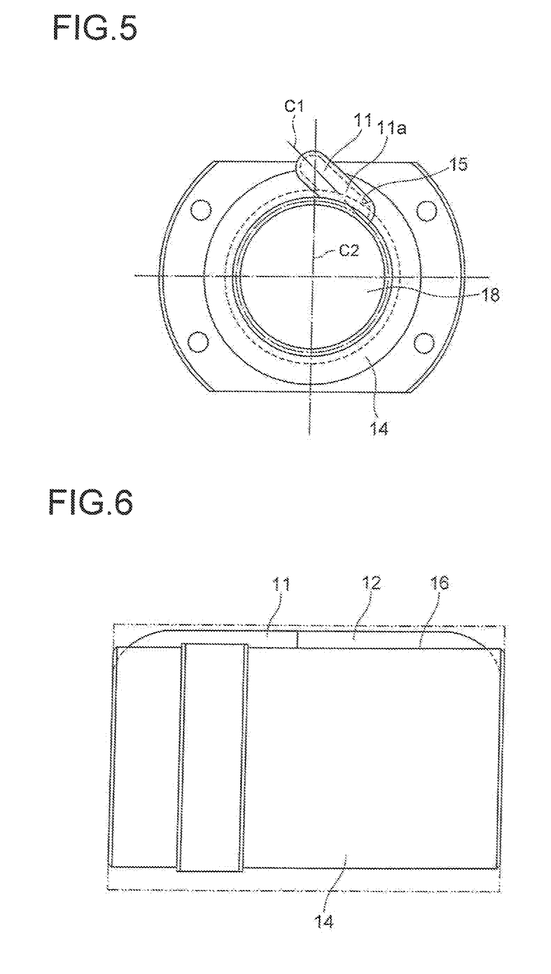

FIGS. 5 and 6 illustrate the first pipe 11 and the second pipe 12 mounted on the nut main body 14. The leg parts 11a and 12a of the first pipe 11 and the second pipe 12, respectively, are fit to notches 15 in the end surfaces 14a of the nut main body 14. The straight parts 11b and 12b of the first and second pipes 11 and 12, respectively, are fit to the side-surface groove 16 of the nut main body 14. As illustrated in FIG. 5, when seen from the axial direction of the screw shaft 18, the center line C1 of the leg part 11a of the first pipe 11 is inclined by a predetermined angle relative to the vertical center line C2 of the ball screw. On the other hand, the center line of the leg part 12a of the second pipe 12 provided opposite to the first pipe 11 is also inclined by the same angle in the direction opposite to the first pipe 11.

The chain double-dashed line in FIG. 6 shows the outer diameter of the nut main body required for a conventional end cap type ball screw. In the end cap type ball screw, as a through hole for ball rolling is formed between the loaded ball rolling groove on the inner surface of the nut main body and the outer diameter of the nut main body, the loaded ball rolling groove and the outer diameter of the nut main body are required to have sufficient thickness in order to prevent their breakage. This thickness has to be a thickness corresponding to the ball diameter at the minimum, and therefore downsizing of the outer diameter of the end cap type ball screw has its limits. On the other hand, in the ball screw of this embodiment, the first and second pipes 11 and 12 are fit into the side-surface groove 16 of the nut main body 14 and the first and second pipes 11 and 12 are exposed on the nut main body 14. As the first and second pipes 11 and 12 jut out the outer surface of the nut main body 14, the outer diameter of the nut main body 14 can be reduced correspondingly.

FIG. 7 illustrates the leg part 11a of the first pipe 11 seen from the inner-diameter side of the nut main body 14. In the leg part 11a, the scooping portion 20 is provided jutting into the ball rolling groove 18a of the screw shaft 18. After each ball 19 has rolled in the ball rolling groove 18a of the screw shaft 18, this scooping portion scoops up the ball 19 and brings the ball into the leg part 11a. Here, the scooping portion 20 may be so-called a boat-bottom shaped scooping portion that does not jut into the ball rolling groove 18a of the screw shaft 18. The boat-bottom shaped scooping portion is configured to scoop up each ball 19 by gradually holding the ball 19 with both side edges of the groove.

FIG. 8 illustrates inclination of the leg part 11a seen in the axial direction of the screw shaft, while FIG. 9 illustrates inclination of the leg part 11a seen from the side-surface side of the screw shaft. The leg part 11a is arranged along the tangential direction of the ball circulation raceway of balls rolling around the screw shaft 18 as shown in FIG. 8, and also arranged along the lead angle direction as shown in FIG. 9. This arrangement of the leg part 11a allows each ball 19 to be scooped up in its travelling direction and no strain is applied from the ball 19 to the leg part 11a. Moreover, as illustrated in FIG. 9, the bottom surface 15a of the notch is inclined by an angle which conforms to the lead angle such that the leg parts 11a and 12a of the first and second pipes 11 and 12, respectively, are arranged along the tangential direction of the ball circulation raceway and along the lead angle direction.

As illustrated in FIGS. 1 and 2, the first pipe 11 and the second pipe 12 are secured to the nut main body 14 with use of a pair of first support members 21 attached to respective end surfaces 14a of the nut main body 14 and a second support member 22 attached to the side surface of the nut main body 14. The first support members 21 hold tight the leg parts 11a and 12a of the first pipe 11 and the second pipe 12, respectively, while the second support member 22 holds tight a joint part of the straight parts 11b and 12b of the first pipe 11 and the second pipe 12, respectively.

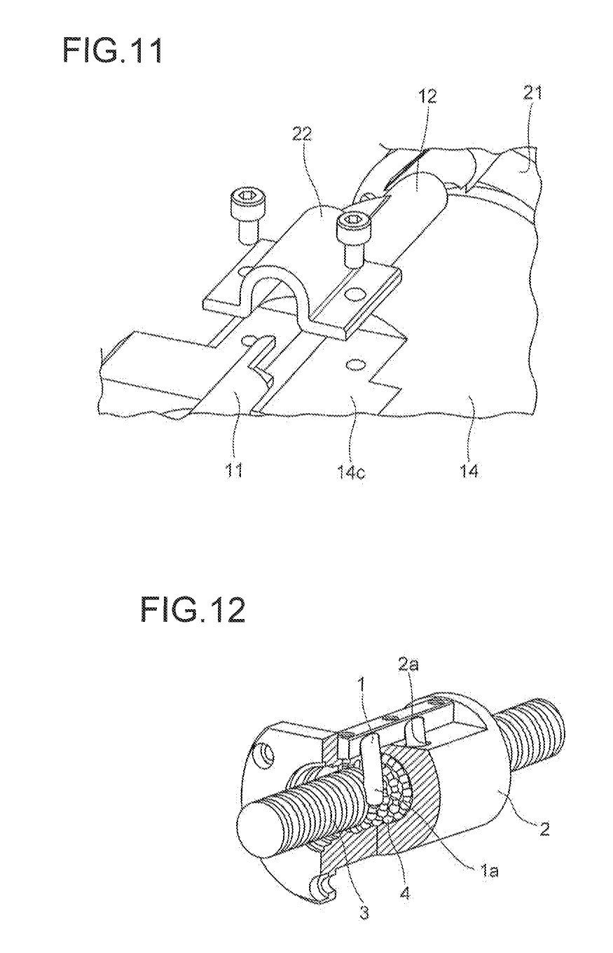

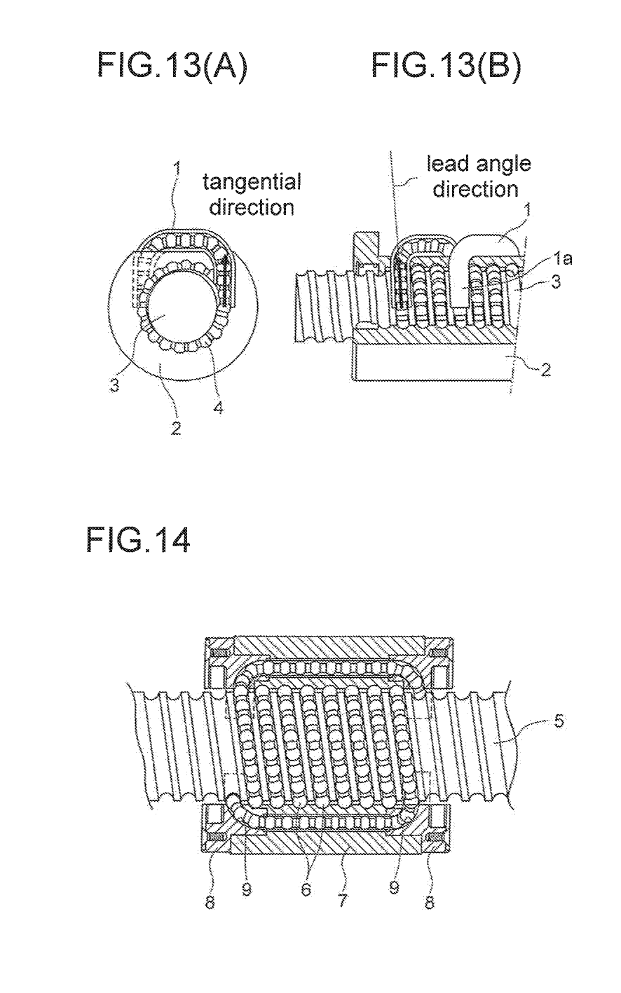

FIG. 10 is a detailed view illustrating a first support member 21. The first support member 21 has a ring-shaped main body part 21a attached to one end surface 14a of the nut main body 14 and a protruding portion 21b protruding from the main body part 21a. The protruding portion 21b conforms to the outer shape of the leg parts 11a and 12a in such a manner that there is no clearance created around the leg parts 11a and 12a of the first and second pipes 11 and 12, respectively, fit into the notches 15. In other words, the first support pipe 21 is formed, for example, by resin molding and in such a manner that its protruding portion 21b is pressed and deformed to conform to the shape of the leg parts 11a and 12a of the first and second pipes 11 and 12. As thus formed, the leg parts 11a and 12a of the first and second pipes 11 and 12 are tightly secured to the nut main body 14 with no play caused around them. The first support member 21 is secured to the nut main body 14 by fastening means such as a bolt. FIG. 11 is a detailed view of the second support member 22. The second support member 22 comprises a stop band of which the center part is bent into U shape. The second support member 22 is attached to a flat notch 14c on the side surface of the nut main body 14.

When necessary, each end surface 14a of the nut main body 14 may be covered by a cover for covering the first support members. Besides, the cover may be equipped with a seal for eliminating foreign matters adhered to the screw shaft 18 and preventing leakage of lubricant from the inside of the nut main body 14.

Next description is made about an assembling method of the ball screw of this embodiment. First, there are prepared a screw shaft 18 having a ball rolling groove 18a formed thereon, a nut main body 14 having a loaded ball rolling groove 14b and notches 15, and two divided pipes, that is, a first pipe 11 and a second pipe 12. Then, the first pipe 11 is moved toward one end surface 14a of the nut main body 14 and a leg part 11a of the first pipe 11 is fit to the notch 15 formed in the one end surface 14a. In this fitting, a straight part 11b of the first pipe 11 is fit to a side-surface groove 16 of the nut main body 14. This is followed by attaching a first support member 21 to the end surface 14a of the nut main body 14 to hold the first pipe 11 with a protruding portion 21b of the first support member 21.

Next, a second pipe 12 is moved toward the other end surface 14a of the nut main body 14, and a leg part 12a of the second pipe 12 is fit to the notch 15 formed in the other end surface 14a. In this fitting, a straight part 12b of the second pipe 12 is fit to a side-surface groove 16 of the nut main body 14, and mating surfaces 11c to 11d of the straight part 11b of the first pipe 11 join with mating surfaces 12c to 12d of the straight part 12b of the second pipe 12. This is followed by attaching a first support member 21 to the end surface 14a of the nut main body 14 to hold the second pipe 12 with a protruding portion 21b of the first support member 21. Then, a second support member 22 is attached to the side surface of the nut main body 14 to hold tight the joint part of the first pipe 11 and the second pipe 12 at the mating-surface portion. Through these steps described up to this point, securing of the first pipe 11 and the second pipe 12 to the nut main body 14 is completed. After this, a ball rolling path between the screw shaft 18 and the nut main body 14, the first pipe 11 and the second pipe 12 are filled with plural balls 19 and spacers 24.

Here, the second support member 22 may be first used to hold tight the mating surfaces 11c to 11d and 12c to 12d of the straight parts 11b and 12b of the first and second pipes 11 and 12, respectively, before the first support members 21 hold tight the leg parts 11a and 12a of the first and second pipes 11 and 12, respectively.

The present invention is not limited to the above-described embodiments and can be embodied in various forms without departing from the scope of the invention. For example, the straight parts of the first and second pipes may tilt and do not have to be in parallel with the axis of the screw shaft. Besides, rollers may be used as rolling elements in place of balls, and spacers are not necessarily required between balls.

The present specification is based on Japanese Patent Application No. 2005-243773 filed on August 25, the entire contents of which are entirely incorporated by reference herein.

1. A rolling-element screw device comprising:
a screw shaft having an outer surface with a rolling-element rolling groove spirally formed thereon;
a nut main body having an inner surface with a loaded rolling-element rolling groove spirally formed thereon facing the rolling-element rolling groove of the screw shaft;
a plurality of rolling elements arranged between the rolling-element rolling groove of the screw shaft and the loaded rolling-element rolling groove of the nut main body; and
a circulation member for, after each of the rolling elements rolls up to one end of the loaded rolling-element rolling groove of the nut main body, scooping up the rolling element and returning the rolling element to an opposite end of the loaded rolling-element rolling groove,
the circulation member having a first pipe and a second pipe each having a scooping portion formed at one end thereof for scooping up each of the rolling elements and a direction change path extending in a curve,
the first pipe being attached to one axial end surface of the nut main body, and
the second pipe being attached to an axially opposite end surface of the nut main body.

2. The rolling-element screw device according to claim 1, wherein the first pipe is fit to a notch formed in the one axial end surface of the nut main body, and the second pipe is fit to a notch formed in the axially opposite end surface of the nut main body.

3. The rolling-element screw device according to claim 2, wherein in a side surface of the nut main body, a side-surface groove is formed linked to the notch formed in the one end surface and the notch formed in the opposite end surface of the nut main body, and the first pipe and the second pipe are fit into the side-surface groove and exposed on the nut main body.

4. The rolling-element screw device according to claim 1, further comprising:
a pair of first support members having main body parts attached to the respective end surfaces of the nut main body and protruding portions conforming to shapes of the first pipe and the second pipe, and being configured to hold the first pipe and second pipe down onto the respective end surfaces of the nut main body; and
a second support member attached to a side surface of the nut main body and being configured to hold the first pipe and the second pipe down onto the side surface of the nut main body at a position of mating surfaces of the first pipe and the second pipe.

5. The rolling-element screw device according to claim 1, wherein mating surfaces of the first pipe and the second pipe include first mating surfaces positioned in planes including center lines of the first pipe and the second pipe, second mating surfaces and third mating surfaces provided away from each other along the respective center lines and at respective opposite sides of the first mating surfaces.

6. A method of assembling a rolling-element screw device having a plurality of rolling elements arranged between a rolling-element rolling groove spirally formed on an outer surface of a screw shaft and a loaded rolling-element rolling groove spirally formed on an inner surface of a nut main body, and a circulation member for, after each of the rolling elements rolls up to one end of the loaded rolling-element rolling groove of the nut main body, scooping up the rolling element and returning the rolling element to an opposite end of the loaded rolling-element rolling groove, the circulation member having a first pipe and a second pipe each having a scooping portion formed at one end thereof for scooping up each of the rolling elements and a direction change path extending in a curve, comprising:
moving the first pipe toward one axial end surface of the nut main body to attach the first pipe thereto;
moving the second pipe toward an axially opposite end surface of the nut main body to attach the second pipe thereto; and
holding the first pipe and the second pipe down onto the nut main body with a support member.
